(19) United States
(12) Patent Application Publication
(10) Pub. No.: US 2013/0036826 A1
(43) Pub. Date: Feb. 14, 2013

(54) MULTIPLE HYDRAULIC CIRCUIT PRESSURE SENSOR

(71) Applicants: Daniel R. Dahlgren, Cicero, IN (US); Daniel A. Lawlyes, Kokomo, IN (US); Markus Naegeli, Kokomo, IN (US); John K. Isenberg, Rossville, IN (US); Lewis Henry Little, Peru, IN (US)

(72) Inventors: Daniel R. Dahlgren, Cicero, IN (US); Daniel A. Lawlyes, Kokomo, IN (US); Markus Naegeli, Kokomo, IN (US); John K. Isenberg, Rossville, IN (US); Lewis Henry Little, Peru, IN (US)

(73) Assignee: DELPHI TECHNOLOGIES, INC., TROY, MI (US)

(21) Appl. No.: 13/695,170

(22) PCT Filed: Jun. 3, 2011
(86) PCT No.: PCT/US11/38982

§ 371 Date: Oct. 29, 2012

Related U.S. Application Data
(60) Provisional application No. 61/351,376, filed on Jun. 4, 2010.

(51) Int. Cl. G01L 9/04; G01L 9/02

(52) U.S. Cl. 73/720; 73/719

(57) ABSTRACT

A hydraulic solenoid assembly for complex vehicle-borne control systems, such as automatic transmissions, includes a solenoid body or unitary housing operatively enclosing two or more solenoid valves. Each valve has a pressure port extending to an outer surface of the housing, emerging in a spaced-apart matrix. A metal (stainless steel or aluminum) sensor plate is mounted to the outer surface of the housing so as to sealingly overlay the pressure ports. A diaphragm is formed in the sensor plate for each solenoid valve and registers with its associated pressure port. Electrical components, such as thick file resistors arranged in a Wheatstone bridge network are printed or mounted to an outer surface of each diaphragm. The bridge networks are electrically connected to a control circuit and function to output signals as a function of hydraulic pressure induced displacement of the associated diaphragm.

### CROSS REFERENCE TO RELATED APPLICATIONS

This application is a national stage application under 35 U.S.C. 371 of PCT Application No. PCT/US2011/038982 having an international filing date of 3 Jun. 2011, which designated the United States, which PCT application claimed the benefit of U.S. provisional patent application Ser. No. 61/351,376 filed 4 Jun. 2010, entitled “Multiple Hydraulic Circuit Pressure Sensor”, the entire disclosure of each of which are hereby incorporated herein by reference.

### TECHNICAL FIELD

The present invention relates generally to hydraulic solenoid valves, and particularly to the control of complex hydraulic systems employing multiple solenoid valves using direct hydraulic circuit pressure sensing techniques.

### BACKGROUND OF THE INVENTION

Known transmission control technology utilizes solenoid “current” sensing to close the control loop within the transmission requiring extremely high precision, costly transmission components to achieve the desired functionality.

Known pressure sensing technology typically consists of individually packaged, self-contained pressure sensors for each hydraulic solenoid circuit. Automotive transmission applications typically require 6-8 sensors, depending on the number of gear ratios employed. Other complex automotive applications, such as anti-lock braking systems (ABS), traction control systems (TCS), active stability control systems (ASCS), and the like often require a similar number of sensors. In addition to being expensive, known sensors are large and can be difficult to package in a confined automotive environment. As a result, closed loop pressure control techniques have not been widely applied to automotive applications.

### SUMMARY OF THE INVENTION

The present invention provides a cost effective, compact/small form factor method to directly sense line pressures of hydraulic control systems within complex automotive hydraulic systems such as automatic transmissions. This is desirable inasmuch as it provides dynamic real time pressure information to the associated controller enabling closed loop pressure control algorithms within the transmission. Closed loop pressure control within the transmission enables easier and more precise transmission closed loop control calibration and can provide better compensation for transmission component wear and fluid contamination over the service life of the transmission. Precise pressure feedback may also enable reduction of transmission parasitic losses through more precise shifting and facilitating “on-demand” transmission fluid pump management, resulting in better vehicle fuel economy and lower CO2 emissions.

These and other features and advantages of this invention will become apparent upon reading the following specification, which, along with the drawings, describes preferred and alternative embodiments of the invention in detail.

### BRIEF DESCRIPTION OF THE DRAWINGS

The present invention will now be described, by way of example, with reference to the accompanying drawings, in which:

FIG. 1, is an exploded, perspective view of a hydraulic solenoid assembly suitable for installation in a vehicle transmission housing including a unitary solenoid body containing six solenoids juxtaposed for assembly with a sensor plate carrying six pressure sensors;

FIG. 2, is a broken, plan view of the underside of a portion of the sensor plate, illustrating a generally circular intermediate pressure sensing diaphragm disposed between two adjacent partial sensing diaphragms;

FIG. 3, is a broken, cross-sectional schematic view of a portion of the sensor plate taken along lines 3-3 of FIG. 2, illustrating the configuration of one of the integrally formed sensing diaphragms;

FIG. 4, is a broken, plan view of the underside of a portion of a first alternative embodiment of the sensor plate, illustrating (in solid line) a pressure sensing diaphragm which is elongated along the longitudinal (X) axis, and (in phantom) a pressure sensing diaphragm which is elongated in the lateral (Y) axis;

FIG. 5, is a broken, cross-sectional schematic view of a portion of a second alternative embodiment of the sensor plate taken, illustrating the configuration of one of the integrally formed sensing diaphragms;

FIG. 6, is a partial cross-sectional, perspective view of the assembled solenoid body with pressure port, the metal sensor plate forming a sensor overlaying the pressure port, and a protective cover overlaying the sensor plate;

FIG. 7, is a cross-sectional view of a portion of the sensor plate defining a sensor diaphragm cavity and associated printed resistors in the relaxed position on an enlarged scale;

FIG. 8, is a cross-sectional view of the sensor of FIG. 12 in a pressurized condition wherein the sensor diaphragm is deflected, thereby subjecting the associated printed resistors to tension or compression; and

FIG. 9, is a schematic of a six pressure cell circuit.

Although the drawings represent embodiments of the present invention, the drawings are not necessarily to scale and certain features may be exaggerated in order to illustrate and explain the present invention. The exemplification set forth herein illustrates an embodiment of the invention, in one form, and such exemplifications are not to be construed as limiting the scope of the invention in any manner.

### DESCRIPTION OF THE PREFERRED EMBODIMENT

The present invention describes a multiple hydraulic circuit pressure sensor for automotive transmission applications. The sensor utilizes thick film electronics printing techniques on a stainless steel or aluminum plate to create a unified structure with multiple sensor locations that can be mounted over multiple solenoid pressure port locations inside the transmission. The plate contains Wheatstone bridge thick film printed resistor configurations over shaped diaphragm locations to measure diaphragm deformation due to applied pressure. In addition, the plate forms its own “circuit board” containing all of the circuit routing and reflow solder electrical components necessary to create a self-contained, functional multiple location sensing circuit. The plate construction is impervious to immersion in hot transmission fluid.

The sensing plate allows several independent sensing locations to be produced in one pass through the manufacturing value stream (e.g. multiple sensing locations are printed all at once, component placement and solder for multiple sensing locations in one pass through SMT, etc.). This results in significantly less manufacturing cost that of processing and packaging each sensor discretely. Early estimates show a significant cost savings over conventional individual in transmission sensor architecture.

Representative thick film pressure sensor technology applicable to the present invention is described in U.S. Pat. No. 5,867,886 to Ratell et al. entitled “Method of Making a Thick Film Pressure Sensor” and in U.S. Pat. No. 5,898,359 to Ellis entitled “Diffusion-Barrier Materials for Thick-Film Piezoresistors and Sensors Formed Therewith”. A representative solenoid valve applicable to the present invention is described in U.S. Pat. No. 6,901,959 B2 to Burrola et al. entitled “Three Port Solenoid Valve”. U.S. Pat. Nos. 5,898,359, 5,867,886 and 6,901,959 are hereby incorporated herein in their entirety by reference.

The preferred embodiment of the present invention is unique inasmuch as it has a very small form factor for ease of packaging inside the host vehicle transmission, its low cost potential, and its durability within the transmission fluid and temperature environment.

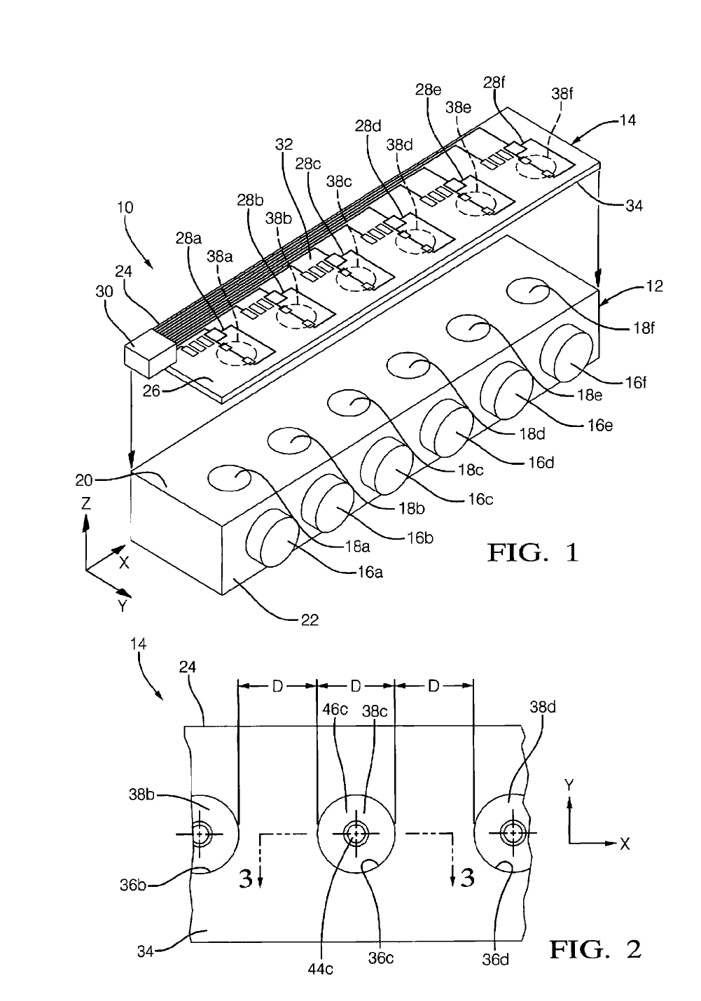

Referring to FIG. 1, a multiple hydraulic circuit device 10 includes a solenoid body assembly 12 and a sensor assembly 14. Although having many possible applications, the device 10 is particularly advantageously applied for hydraulic control solenoids located inside an automotive transmission, submerged in automatic transmission fluid. The solenoid body assembly 12 houses a plurality (six are illustrated) of solenoid valves 16a-16f, each having an associated pressure port 18a-18f opening through a common planer upper surface 20. The pressure ports 18a-18f are equally spaced and aligned along a longitudinal axis (X) of elongation. The solenoid valves 16a-16f emerge from a side wall 22 of body assembly 12.

The sensor assembly 14 is built on a single stainless steel or aluminum plate 24 which is elongated along axis X. The plate 24 has an upper surface 26 having six resistor bridge circuits 28a-28f, a multi-circuit connector 30 and interconnecting conductive traces 32 formed thereon. The connector 30 is configured for electrically interfacing the device 10 with the power supply and control circuitry (not illustrated) of an associated host vehicle. The plate 24 has a lower surface 34 which overlays the upper surface 20 of the solenoid body assembly 20 to sealingly close the pressure ports 18a-18f at their point of emergence through upper surface 20.

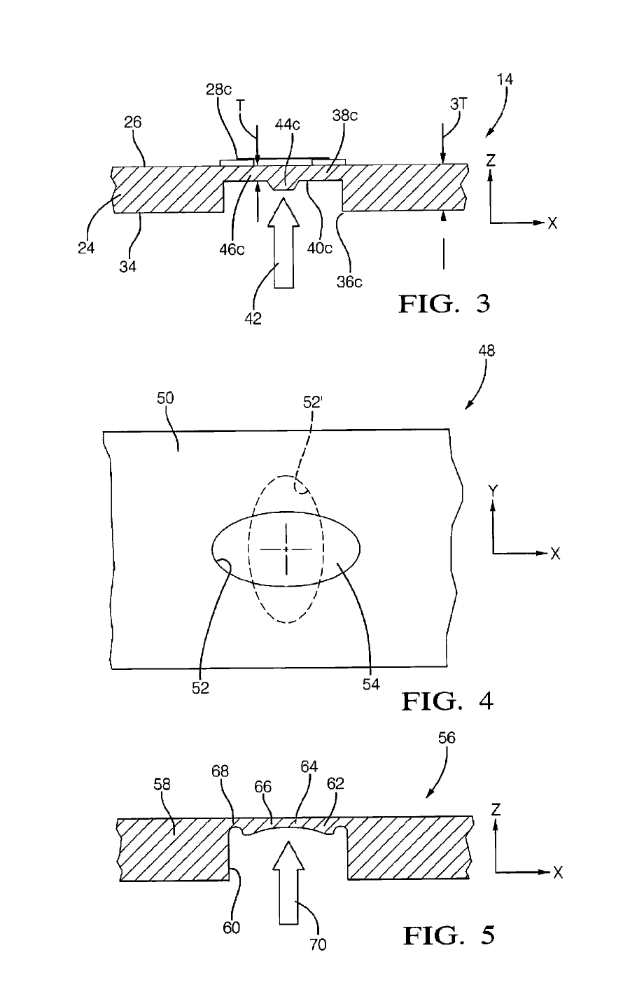

Referring to FIGS. 2 and 3, a broken, representative portion of the sensor assembly 14 illustrates details thereof on an enlarged scale. A blind bore or recess 36a-36f associated with each resistor bridge circuit 28a-28f opens downwardly through the lower surface 34 of the sensor plate 24 in register with an associated underlying pressure port 18a-18f. Each recess 36a-36f is closed adjacent the upper surface 26 of the sensor plate 24 by an associated diaphragm 38a-38f integrally formed with the material forming the balance of the sensor plate 24.

In application, pressurized hydraulic fluid within pressure ports 18a-18f is applied against the lower surface 40a-40f of each associated diaphragm 38a-38f, locally distending the diaphragm 38a-38f upwardly as a function of hydraulic fluid pressure as indicated by arrow 42.

Nominally, each diaphragm has a thickness “T”, and the supportive adjacent portion of the sensor plate 24 has a thickness of “3T”. Furthermore, each blind bore 36a-36f has a nominal diameter “D” and is spaced from adjacent blind bores at least by dimension “D”. Such dimensional relationships provide a robust design wherein the diaphragms can locally flex while the supportive portions of the sensor plate remain rigid, preventing leakage of hydraulic fluid and “cross-talk” between adjacent diaphragms 38a-38f.

The dimensions and shape of the diaphragms 38a-38f can be altered as required for a given application. The embodiment illustrated in FIGS. 1-3 depict round diaphragms 38a-38f, each having a thickened center portion 44a-44f and a concentric outer portion 46a-46f.

Referring to FIG. 4, a sensor assembly 48 includes a sensor plate 50 defining an oval shaped blind bore 52 elongated, by way of example, along the X axis or, alternatively, (in phantom) along the Y axis as 52′. As viewed from a bottom perspective, blind bore 52 is closed by a similarly elongated diaphragm 54.

Referring to FIG. 5, another alternative embodiment of the present invention illustrates a sensor assembly 56 having a sensor plate 58 forming a blind bore 60 closed by a diaphragm 62 having a relatively thin center portion 64, a radially tapered intermediate portion 66 and locally thinned outermost portion 68. The shape of the diaphragm can be altered to tailor displacement thereof when transitioning between a relaxed (unpressurized) position and a distended (pressurized) position as referenced by arrow 70.

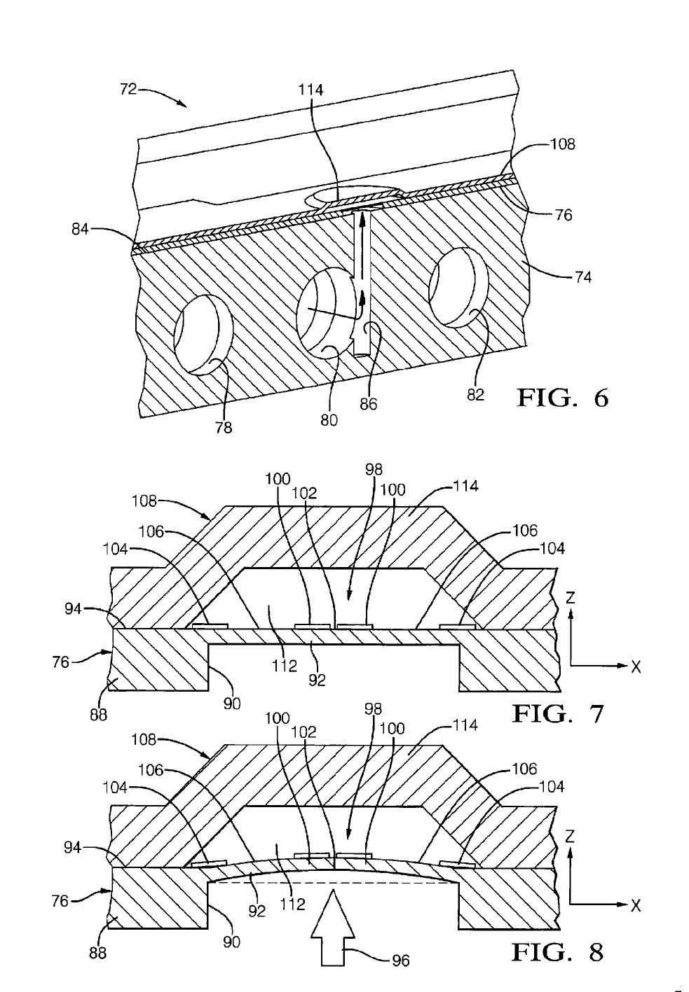

Referring to FIGS. 6-8, yet another embodiment of the present invention is illustrated. A multiple hydraulic circuit device 72 includes a solenoid body or housing 74 (solenoids are not illustrated for the sake of simplicity) with a sensor assembly 76 mounted thereon. The solenoid body 74 forms passageways 78, 80 and 82 for receiving solenoid mechanisms therein and routing hydraulic fluid. Passageway 80 hydraulically communicates with the upper surface 84 of solenoid body 74 through a pressure port 86. The sensor assembly 76 includes a sensor plate 88 forming a blind bore 90 therein registering with the pressure port 86. The blind bore 90 is closed by a diaphragm 92 located adjacent the upper surface 94 of the pressure plate 88. The diaphragm 92 is relatively thin and is locally displaceable under the influence of pressurized hydraulic fluid as indicated by arrow 96.

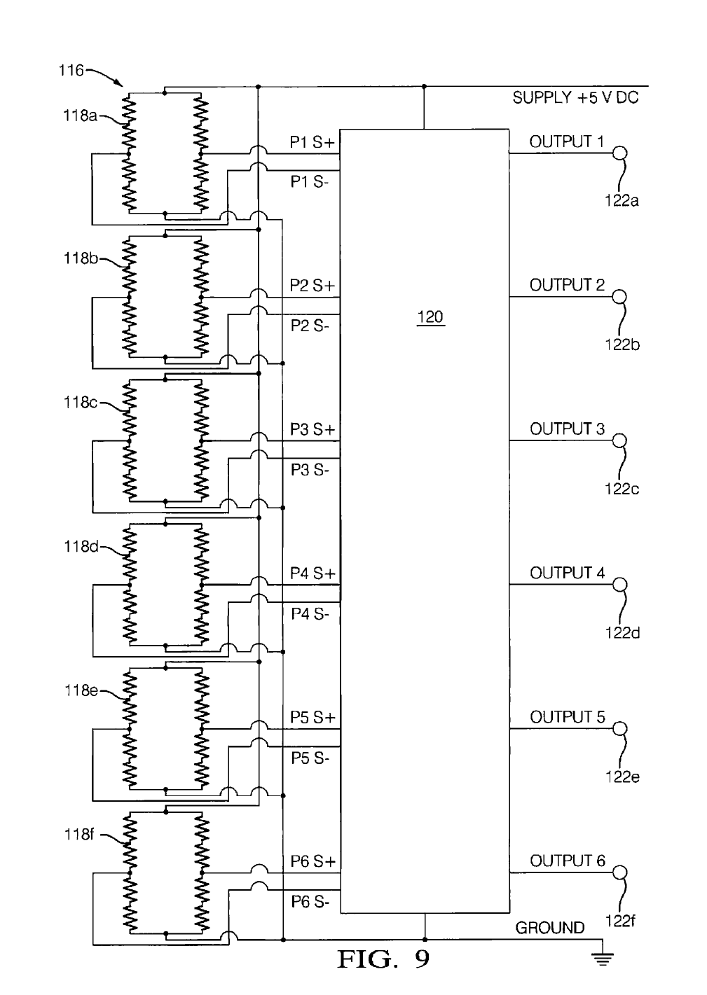

A protective member 108 overlays the upper surface 94 of the sensor plate 88 and is secured in assembly with the solenoid body 74 by through-fasteners (not illustrated) compressively securing the sensor plate 88 in its illustrated position. The protective member 108 prevents displacement of the sensor plate 88, and thus, cross-talk between adjacent resistor bridge circuits 98. The protective member 108 has a relief feature 110 formed therein located concentrically with an underlying diaphragm 92. The relief feature 110 forms a cavity 112 and includes a top portion 114 spaced above the diaphragm 92, enabling clearance along the Z axis for momentary displacement of the diaphragm 93 as depicted in FIG. 8.

A resistor bridge network 98 is printed on the outer surface 94 of the diaphragm 92. The resistor bridge network 98 has a first set (one or more) of resistors 100 located in a central region 102 of the diaphragm 92 which are subjected to substantially tensile loading when the underlying diaphragm 92 is displaced from an unloaded or rest position (as illustrated in FIG. 7) to a deflected or loaded position (as illustrated in FIG. 8), and a second set (one or more) of resistors 104 located in an outer region 106 of the diaphragm 92 which are subjected to substantially compressive loading when the underlying diaphragm 92 is displaced from an unloaded or rest position (as illustrated in FIG. 7) to a deflected or loaded position (as illustrated in FIG. 8).

The first set of resistors 100, being located in the central region 102 are stretched or subjected to tensile loading as a result of the diaphragm 92 being deformed from the position illustrated in FIG. 7 to the position illustrated in FIG. 8. Conversely, the second set of resistors 104 are compressed or subjected to compressive loading as a result of the diaphragm 92 being deformed from the position illustrated in FIG. 7 to the position illustrated in FIG. 8. Preferably, a portion of each of the second set of resistors 104 is effectively fixedly grounded to a relatively non-displaceable, relatively thick portion of the pressure plate 88 and an opposed portion of each of the second set of resistors 104 is effectively carried for displacement with the outer region 106 of the diaphragm 92 being deformed from the position illustrated in FIG. 7 to the position illustrated in FIG. 8.

Referring to FIG. 9, an electrical block diagram 116 depicting a six cell sensor circuit is illustrated. A plurality of cells 118a-118f are each in-circuit with a compensator array 120 along with a suitable power supply and an electrical ground. Each cell 118a-118f is associated with a single diaphragm and the first and second sets of printed resistors collectively forming a Wheatstone bridge. The compensator array 120 provides output signals on output lines 122a-122f, each corresponding with one of the cells 118a-118f.

It is to be understood that the invention has been described with reference to specific embodiments and variations to provide the features and advantages previously described and that the embodiments are susceptible of modification as will be apparent to those skilled in the art.

Furthermore, it is contemplated that many alternative, common inexpensive materials can be employed to construct the basis constituent components. Accordingly, the forgoing is not to be construed in a limiting sense.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, wherein reference numerals are merely for illustrative purposes and convenience and are not in any way limiting, the invention, which is defined by the following claims as interpreted according to the principles of patent law, including the Doctrine of Equivalents, may be practiced otherwise than is specifically described.

1. A multiple hydraulic circuit pressure sensor comprising:
a unitary sensor plate configured for mounting adjacent an outer surface of a multi-solenoid housing assembly to overlay a plurality of ports formed therein;
a plurality of diaphragms formed in said plate, each said diaphragm positioned to overlay an associated port; and
an array of thick film resistors printed on an external surface of each said diaphragm, each said array forming a Whetstone resistor network operative to output electrical signals as a function of hydraulic fluid pressure induced displacement of an associated diaphragm.

2. In combination:
a hydraulic solenoid assembly comprising:
a housing,
a plurality of solenoid valves operatively carried within said housing, and
at least two pressure ports, each said port extending from an associated solenoid valve to an opening on an outer housing surface; and
a sensor assembly comprising:
a unitary sensor plate configured for mounting adjacent said housing surface overlaying said ports,
a plurality of diaphragms integrally formed in said plate, each said diaphragm positioned to overlay an associated port, and
an array of thick film resistors printed on an external surface of each said diaphragm, each said array forming a Wheatstone resistor network operative to output electrical signals as a function of hydraulic fluid pressure induced displacement of an associated diaphragm.

3. The combination of claim 2, wherein said sensor assembly further comprises a sensor compensation integrated circuit and surface mount signal conditioning components carried on said plate outer surface adjacent each associated diaphragm.

4. The combination of claim 3, wherein said sensor assembly further comprises a multi-conductor connector and discrete conductor traces carried on said plate outer surface and extending to each resistor network.

5. The combination of claim 2, wherein each said resistor network comprises a first set of resistors disposed adjacent an outer edge portion of an associated diaphragm for compression loading upon hydraulic fluid pressure induced displacement of said associated diaphragm, and a second set of resistors disposed adjacent a center portion of an associated diaphragm for tension loading upon hydraulic fluid pressure induced displacement of said associated diaphragm.

6. The combination of claim 2, wherein said diaphragms are each symmetrically formed and aligned along a longitudinal axis of elongation of said sensor plate.

7. The combination of claim 6, wherein said diaphragms are each substantially of round configuration, having a characteristic diameter of dimension D.

8. The combination of claim 7, wherein said diaphragms are longitudinally spaced apart by a dimension D.

9. The combination of claim 6, wherein at least one of said diaphragms is elongated along the longitudinal axis or lateral axis of said sensor plate.

10. The combination of claim 2, wherein at least one of said diaphragms has a substantially constant characteristic thickness.

11. The combination of claim 2, wherein at least one of said diaphragms has a thickened portion.

12. The combination of claim 11, wherein said thickened portion of said diaphragms is radially inwardly tapered.

13. The combination of claim 11, wherein said thickened portion of said diaphragms is radially outwardly tapered.

14. The combination of claim 2, wherein each said diaphragm has a nominal thickness of dimension T, and surrounding portions of said sensor plate has a nominal thickness of substantially 3T.

15. The combination of claim 2, wherein said sensor plate is formed from stainless steel or aluminum.

16. The combination of claim 2, further comprising a protective cover overlaying an outer surface of said sensor plate.

17. The combination of claim 16, wherein said protective cover is of unitary construction and has characteristic longitudinal and lateral dimensions substantially equaling those of said sensor plate.

18. The combination of claim 16, wherein said protective cover forms a plurality of relief structures therein, each relief structure extending outwardly from said sensor plate and disposed substantially concentrically with an associated diaphragm.

19. The combination of claim 18, wherein each said relief structure forms a top wall portion disposed substantially parallel with and spaced above an associated diaphragm.

20. The combination of claim 19, wherein each said relief structure has a shape configuration substantially mimicking an associated underlying diaphragm.
